(19) United States
(12) Patent Application Publication
(10) Pub. No.: US 2023/0070525 A1
(43) Pub. Date: Mar. 9, 2023

(54) SYSTEM AND METHOD FOR WORK QUALITY ASSURANCE IN VEHICLE MANUFACTURING

(71) Applicant: TEIA Co., Ltd., Anyang-si (KR)

(72) Inventors: CHOONJAE LEE, Seoul (KR); BYEONGHEE YOUN, Yongin-si (KR); SANG WOOK PARK, Suwon-si (KR); TAE WOO OH, Seoul (KR)

(73) Assignee: TEIA Co., Ltd., Anyang-si (KR)

(21) Appl. No.: 17/939,966

(22) Filed: Sep. 8, 2022

(30) Foreign Application Priority Data
Sep. 9, 2021 (KR) 10-2021-0120695

(51) Int. Cl. G05B 19/418

(52) U.S. Cl. CPC G05B 19/41875; G05B 2219/32204; G05B 2219/45054

(57) ABSTRACT

Provided are a system and method for work quality assurance in vehicle manufacturing, which are capable of preventing defects in manufacturing, wherein the system for work quality assurance in vehicle manufacturing which assembles fastening objects to a vehicle transferred through a conveyor line through a working unit, includes a server configured to set a working area of the vehicle, assign work corresponding to the working area, check a position of the working unit in real time to calculate a stay period during which the working unit stays in the working area, receive work information from the working unit, and determine whether the work is successful on the basis of the stay period, the assigned work, and the work information.

### CROSS-REFERENCE TO RELATED APPLICATION

This application claims priority to and the benefit of Korean Patent Application No. 2021-0120695, filed on Sep. 9, 2021, the disclosure of which is incorporated herein by reference in its entirety.

### BACKGROUND

### 1. Field of the Invention

The present invention relates to a system and method for work quality assurance in vehicle manufacturing.

### 2. Discussion of Related Art

Generally, automobile manufacturers assemble tens of thousands of parts through numerous welding and assembling processes in all mass production processes until the production of automobiles.

In particular, most of the work performed in an assembly process among production processes of finished cars is a fastening process in which various parts are fastened to a body in white using coupling members such as bolts, nuts, and the like.

Since such a fastening process is directly related to the quality index of the vehicle that consumers feel, such as durability or quietness of the finished car, it is necessary to thoroughly manage the fastening history of parts with respect to the body in white.

However, although the industry recognizes the importance of managing a fastening history of parts with respect to a body in white, effective management of the fastening history is not properly performed due to technical limitations.

### Document of Related Art

Korean Patent Registration No. 10-1461908 (registered on Nov. 8, 2014)
Korean Patent Registration No. 10-1427973 (registered on Aug. 1, 2014)

### SUMMARY OF THE INVENTION

The present invention is directed to providing a system and method for work quality assurance in vehicle manufacturing, which are capable of preventing defects in manufacturing. The scope of the present invention is limited thereto.

According to an aspect of the present invention, there is provided a system for work quality assurance in vehicle manufacturing, which assembles fastening objects to a vehicle transferred through a conveyor line through a working unit, the system including a server configured to set a working area of the vehicle, assign work corresponding to the working area, check a position of the working unit in real time to calculate a stay period during which the working unit stays in the working area, receive work information from the working unit, and determine whether the work is successful on the basis of the stay period, the assigned work, and the work information.

The work information may include a working time, at which the working unit completes the work, and a result of the work.

When the working time corresponding to the work and the result of the work are satisfied during the stay period, the server may determine that the work is successful.

When the working time corresponding to the work and the result of the work are not satisfied during the stay period, the server may command to stop the conveyor line.

According to another aspect of the present invention, there is provided a system for work quality assurance in vehicle manufacturing, which assembles fastening objects to a vehicle transferred through a conveyor line through a working unit, the system including a server configured to set a working area of the vehicle, assign work corresponding to the working area, and check a position of the working unit in real time, wherein the server performs (a) an operation of setting a working area of the vehicle, (b) an operation of assigning work corresponding to the working area, (c) an operation of determining whether the working unit has entered the working area, (d) and (e) operations of generating and storing entry information when the working unit enters the working area, and determining whether the working unit has exited the working area, (f) and (g) operations of receiving work information from the working unit and storing the received work information, (h) an operation of, when it is determined in operation (e) that the working unit has exited the working area, generating and storing exit information, (i) an operation of mapping product information of the vehicle and the work information, and (j) an operation of determining whether the work is successful on the basis of the entry information, the exit information, the work, and the work information of the vehicle.

The server may calculate a stay period during which the working unit stays in the working area on the basis of the entry information and the exit information, and when the work information indicating that the work is performed within the stay period is present, the server may determine that the work is successful.

When the work information including a working time and a result of the work is present within the stay period and when the result of the work is normal, the server may determine that the work is successful.

The server may map the entry information and the exit information to the product information.

According to still another aspect of the present invention, there is provided a work quality assurance method performed by a system for work quality assurance in vehicle manufacturing, which assembles fastening objects to a vehicle transferred through a conveyor line through a working unit, the system including a server configured to set a working area of the vehicle, assign work corresponding to the working area, and check a position of the working unit in real time, wherein the server performs (a) a setting operation of setting a working area of the vehicle, (b) a work assignment operation of assigning work corresponding to the working area, (c) an entry determination operation of determining whether the working unit has entered the working area, (d) an entry information storage operation of generating and storing entry information when the working unit enters the working area, (e) an exit determination operation of determining whether the working unit has exited the working area, (f) a work information receiving operation of receiving work information from the working unit, (g) a work information storage operation of storing the work information, (h) an exit information storage operation of generating and storing exit information when the working unit exits the working area in operation (e), (i) a work information mapping operation of mapping product information of the vehicle and the work information, and (j) a work quality determination operation of determining whether the work is successful on the basis of the entry information, the exit information, the work, and the work information of the vehicle.

In the work quality determination operation, when the work information including a working time and a result of the work is present within a stay period and the result of the work is normal, the server may determine that the work is successful.

The server may map the entry information and the exit information to the product information.

Other aspects, features, and advantages other than those described above will become apparent from the following detailed description, appended claims, and the accompanying drawings for embodying the present invention.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram schematically illustrating a system for work quality assurance in vehicle manufacturing according to an embodiment of the present invention;

FIGS. 2 and 3 are flowcharts schematically illustrating a system and method for work quality assurance in vehicle manufacturing according to an embodiment of the present invention;

FIG. 4 is a diagram schematically illustrating an example of a system and method for work quality assurance in vehicle manufacturing according to an embodiment of the present invention; and

FIGS. 5 and 6 are flowcharts schematically illustrating a system and method for work quality assurance in vehicle manufacturing according to another embodiment of the present invention.

### DETAILED DESCRIPTION OF EXEMPLARY EMBODIMENTS

Hereinafter, various embodiments of the present invention are disclosed with reference to the accompanying drawings. While the present invention is open to various modifications and alternative forms, specific embodiments thereof are shown by way of example in the drawings and will herein be described in detail. However, it should be understood that there is no intent to limit the present invention to the particular forms disclosed, and on the contrary, the present invention is to cover all modifications, equivalents, and/or alternatives falling within the spirit and scope of the present invention. With respect to the descriptions of the drawings, like reference numerals may be used for like elements.

Expressions such as “comprises,” “includes,” “may comprise,” and “may include” that may be used in various embodiments of the present invention indicate the presence of the disclosed corresponding function, operation, or elements, and do not limit one or more additional functions, operations, or elements. Further, in various embodiments of the present invention, it should be understood that the terms “comprise,” “comprising,” “include,” and/or “including,” when used herein, specify the presence of stated features, integers, steps, operations, elements, parts, and/or combinations thereof, but do not preclude the presence or addition of one or more other features, integers, steps, operations, elements, parts, and/or combinations thereof.

In various embodiments of the present invention, expressions such as “or” and the like may indicate any and all combinations of words listed together. For example, “A or B” may include A, may include B, or may include both A and B.

Expressions such as “first,” “second,” and the like used in various embodiments of the present invention may modify various elements of various embodiments, and do not limit corresponding elements. For example, the above expressions do not limit the order and/or importance of corresponding elements. The above expressions may be used to distinguish one element from another element. For example, both a first user device and a second user device are user devices, and represent different user devices. For example, a first element could be termed a second element, and similarly, a second element could be termed a first element without departing from the scope of various embodiments of the present invention.

It will be understood that when an element is referred to as being “connected” or “coupled” to another element, an element can be directly connected or coupled to another element or a new element can be present between the two elements. In contrast, it will be understood that when an element is referred to as being “directly connected” or “directly coupled” to another element, there are no intervening elements present between the two elements.

Terms used in various embodiments of the present invention are only used to describe one specific embodiment, and are not intended to limit the various embodiments of the present invention. As used herein, the singular forms “a” and “an” are intended to include the plural forms as well, unless the context clearly indicates otherwise.

Unless otherwise defined, all terms including technical and scientific terms used herein have the same meaning as commonly understood by one of ordinary skill in the art to which various embodiments of the present invention pertain.

It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

Hereinafter, a system may include at least any one, some of, or all of a configuration of devices, a method of operating the devices, a computer program executing a method of operating devices, and a medium in which a computer program is recorded.

A vehicle used throughout this specification includes not only a finished vehicle but also a body in white being assembled on a production line, and moving the vehicle means that the vehicle is moved by a moving part such as a conveyor, not by its own power.

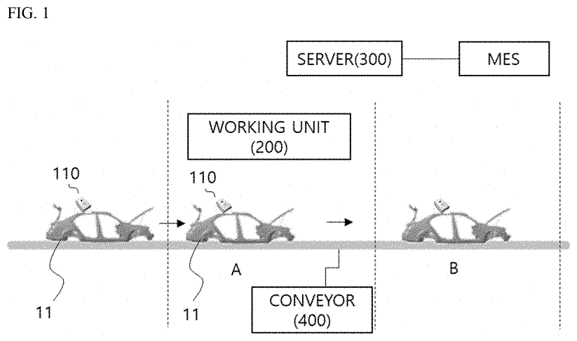

FIG. 1 is a conceptual diagram schematically illustrating a system for work quality assurance in vehicle manufacturing according to an embodiment of the present invention. The system for work quality assurance in vehicle manufacturing is a system that assures results obtained by performing, by a worker, a tool 210, equipment, etc., welding and fastening of fastening objects to a body in white, which is transferred through a conveyor line.

The system for work quality assurance includes a server 300. The server 300 may check a position of at least one of the worker, the tool 210, and the equipment in real time, and manage work results of the worker, the tool 210, and the equipment. Further, the server 300 may store data or include a database in which data is stored. Further, the server 300 may include a central processing unit (CPU) and a communication module to process data and electrically communicate with an external device.

To help with understanding of the present invention, a working process for manufacturing a vehicle 11 will be described.

The vehicle 11 has an identification (ID) code. The ID code may be a vehicle ID number (VIN) or an associated code for identifying at least the same unique vehicle 11.

A vehicle tag device 110 is attached to the vehicle 11 in order to manage the vehicle 11. The vehicle tag device 110 may be attached to each vehicle 11 and moved together with the vehicle 11. For example, the vehicle tag device 110 is attached to the vehicle 11 through a magnet or the like, and moved together with the vehicle 11 as the vehicle 11 is moved by a conveyor. Then, when the process is completed, the vehicle tag device 110 may be removed from the vehicle 11.

Each vehicle tag device 110 may have a tag ID. The vehicle tag device 110 may communicate with the server 300 through a gateway or the like. For example, the vehicle tag device is an active element, and may include ultra-wideband (UWB), radio frequency ID (RFID), or the like to communicate with the server 300.

Further, the vehicle tag device 110 may store vehicle information, process information, a VIN, and the like of the vehicle 11 to which the vehicle tag device 110 is attached. Thereafter, the server 300 or a manufacturing execution system (MES) may manage the vehicle 11 by mapping the tag ID and an ID number of the vehicle tag device 110. The server 300 or the MES may manage the vehicle 11 on the basis of the ID number of the vehicle 11. Hereinafter, information including an ID of the vehicle tag device 110, information included therein, an ID number of the vehicle 11, and the like is referred to as product information.

Here, the MES is a manufacturing execution system and includes a processor, a database, a communication module, and the like.

A working unit 200 performs a task of fastening parts or attaching accessory parts to the vehicle 11. The work includes a main task and a sub-task. The main task may include several sub-tasks. Of course, the present invention is not limited thereto, and the main task and the sub-task may be the same.

For example, the main task may be a task of fastening a panel to the body in white, and the sub-task may be a task of tightening three bolts in order to fasten the panel to the body in white. As another example, the main task may be a liquid injection task, and the sub-task may also be a liquid injection task.

Specifically, the working unit 200 may include at least one of the worker, the tool 210, and the equipment. Further, the working unit 200 may include a tag device capable of checking the positions of the worker, the tool 210, and the equipment, and may include a control unit 220 that is connected to the worker, the tool 210, and the equipment.

For example, the working unit 200 may be the tool 210, and specifically, may be a fastening tool 210 (or hand tool 210) or a liquid injection device. The equipment may be a robot or a machine, which moves, fastens, or welds various parts of a vehicle. Hereinafter, to help with understanding of the present invention, the fastening tool 210 and a fastening task will be described. However, the present invention is not limited thereto.

The tag device may be attached or provided to the worker, the tool 210, and the equipment in order to track the positions of the worker, the tool 210, and the equipment. For example, the tag device may be attached to the worker and the tool 210, and the equipment itself may include a tag device for position tracking.

Further, the tag devices, the tool 210, and the equipment may include UWB, RFID, or the like to communicate with the server 300. Of course, a gateway may be provided between the tag devices, the tool 210, and the equipment and the server 300, and the tag devices, the tool 210, and the equipment and the server 300 may communicate with each other.

The working unit 200 may include a control unit 220, such as a personal terminal, a controller, a programmable logic controller (PLC), or the like, which is connected to the worker, the tool 210, and the equipment. Here, the personal terminal may be a smartphone, a personal computer (PC), or the like, which is used by the worker. The control unit 220 may receive a task assigned by the server 300 and transmit the assigned task to the worker, the tool 210, and the equipment. That is, the worker, the tool 210, and the equipment may receive a work instruction, work content, and the like through the control unit 220.

Further, the control unit 220 may control the tool 210 and the equipment or transmit work information to the server 300. The controller or the PLC may receive a task from the server 300 and control the tool 210 or the equipment. The personal terminal may receive a task from the server 300, and display the task to the worker or inform the worker of the task.

The server 300 may serve to perform overall control of the system for work quality assurance of the vehicle 11, which assembles the fastening objects to the vehicle 11 transferred through the conveyor line through the working unit 200. Here, the working unit 200 refers to at least one of the above-described worker, tool 210, and equipment.

The server 300 may check the position of the working unit 200, that is, at least one of the worker, the tool 210, and the equipment, in real time. Further, the server 300 may manage the work result of the working unit 200. In this case, the server 300 may receive a signal from the tag device to check the position of the working unit 200.

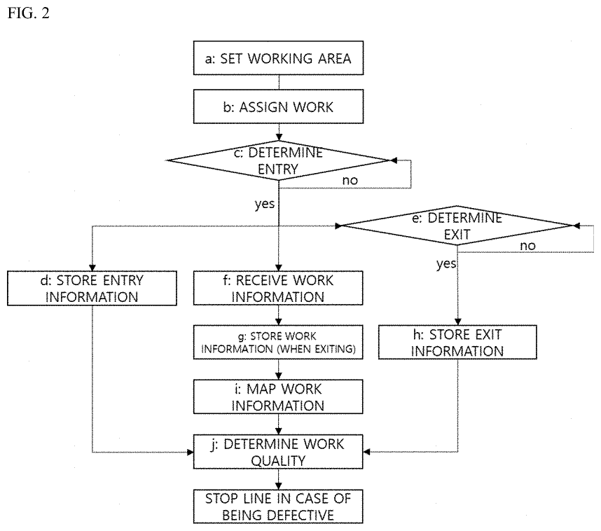

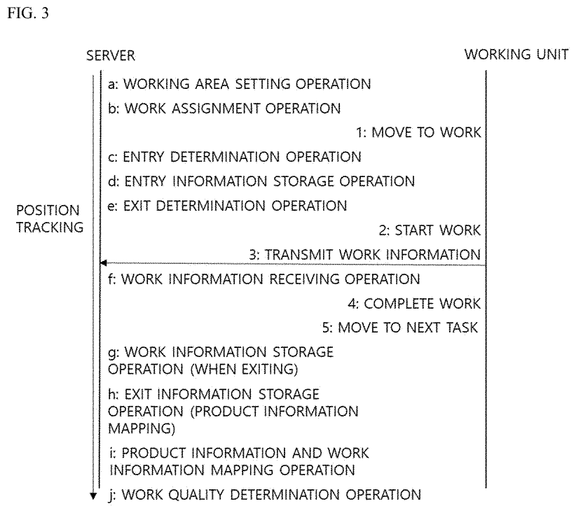

FIGS. 2 and 3 are flowcharts schematically illustrating the system for work quality assurance of the vehicle 11 according to the embodiment of the present invention.

The server 300 may check the position of a working unit 200 in real time. For example, as described above, the server 300 may receive coordinates of the working unit 200 through the tag device attached to the working unit 200, and check the position of the working unit 200.

The server 300 may consecutively track the position of the working unit 200 while the process of assembling the vehicle 11 is performed. That is, the server 300 will be described below under the assumption that the position on the working unit 200 is checked in real time. Of course, the present invention is not limited thereto, and the server 300 may separately start or end the position tracking of the working unit 200.

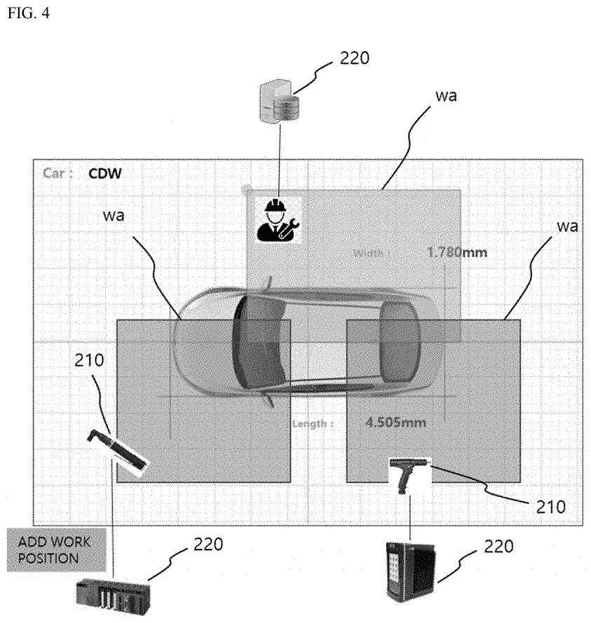

In operation (a), the server 300 may set working areas wa of the vehicle 11. Specifically, as illustrated in FIG. 4, the server 300 may set areas in which work on the vehicle 11 is required, such as front, rear, left, and right sides of the vehicle 11. Since various parts need to be fastened to the vehicle 11, it is very important to set the work order and the working areas wa. By setting the working areas wa, it is possible to manage the type of work for each working area wa and the work order. Further, the server 300 may set the working areas wa required for the vehicle 11 and manage the processes to proceed sequentially without omission.

To describe the setting of the working areas wa in more detail, the server 300 stores a plurality of preset working areas wa. Then, when the vehicle 11 enters corresponding process areas A and B, the server 300 may call the plurality of preset working areas wa and set a current working area wa of the vehicle 11 as predetermined. As another example, when the vehicle 11 enters the process areas A and B, a person (operator) may set a working area wa for each vehicle 11. The server 300 may receive the working area wa set by the person, and re-set the working area wa.

In this case, the server 300 may internally set the working area wa and display the set working area wa to a user.

In operation (b), when the server 300 sets the working area wa, the server 300 assigns work corresponding to the working area wa through the working unit 200. Here, the work may be a work list or data on work to be performed by the working unit 200. For example, the server 300 may assign a list of main and sub-tasks for fastening three fastening parts.

In this case, the server 300 may internally assign a task corresponding to the working area wa from among pre-stored tasks. Alternatively, the server 300 may assign work using the control unit 220, such as the PLC, the controller, the personal terminal, or the like, which is connected to the working unit 200.

1. Meanwhile, when the vehicle 11 enters the process areas A and B, the working unit 200 may start the work. That is, the working unit 200 may enter the process areas A and B independently of whether a work instruction is given, and perform the work. For example, when the vehicle 11 enters the process areas A and B, the worker may approach the vehicle 11 with the tool 210 to which the tag device is attached, and perform a given task (e.g., task of fastening three fastening parts).

In this case, the tag device that checks the position of the working unit 200 consecutively transmits coordinates of the working unit 200 to the server 300. Of course, when a process of manufacturing the vehicle 11 starts, the tag device consecutively transmits the coordinates of the working unit 200 to the server 300.

In operation (c), the server 300 may determine whether the working unit 200 has entered the working area wa. The server 300 receives a current position of the working unit 200 and determines whether the working unit 200 has entered the set working area wa. Specifically, the server 300 may consecutively receive the coordinates of the tool 210, the worker, and the equipment from the tag devices, and consecutively check whether the tool 210, the worker, and the equipment are present in the set working area wa to determine whether the tool 210, the worker, and the equipment has entered the set working area wa.

When it is determined that the working unit 200 has not entered the working area wa, the server 300 may determine whether or not the working unit 200 enters the working area wa until the working unit 200 enters the working area wa. Additionally, the server 300 may notify or command the working unit 200 to enter the working area wa.

In operation (d), when it is determined that the working unit 200 has entered the working area wa, the server 300 may generate and store entry information. In this case, the entry information may include a time at which the working unit 200 enters the working area wa, and may additionally include a tag ID indicating the type of tool 210. That is, the entry information may include information (entry time) on when the working unit 200 enters, or may include information on which working unit 200 (e.g., worker, tool 210, or equipment) enters and when the working unit 200 enters.

In this case, the server 300 may map and store the entry information and the above-described product information (e.g., tag ID of the vehicle tag device 110 or ID number of the vehicle 11). Accordingly, the vehicle 11 may manage work details and work quality.

In operation (e), simultaneously with operation (d) or within a predetermined period, the server 300 determines whether the working unit 200 has exited the working area wa. In other words, the tag device of the working unit 200 consecutively transmits information on the position of the working unit 200 to the server 300. Therefore, the server 300 may consecutively check the position of the working unit 200.

When it is determined that the working unit 200 has entered the working area wa, the server 300 may consecutively determine whether the working unit 200 has exited the working area wa.

2. When the vehicle 11 enters the process areas A and B, the working unit 200 (more specifically, the tool 210, the equipment, or the worker) performs the predetermined main and sub-tasks, as described above. In this case, even when the working unit 200 does not receive a work instruction from the server 300, the working unit 200 performs the main and sub-tasks when the vehicle 11 enters the process areas A and B. Of course, the present invention is not limited thereto.

3. Then, the working unit 200 transmits work information to the server 300. In this case, the working unit 200 may transmit the work information to the server 300 through the control unit 220 or the tag device.

The work information includes information on a work completion time and work result. More specifically, when the work is a main or sub-task in which three fastening parts are to be fastened, the working unit 200 transmits a work completion time and a work result every time the work is performed on one fastening part. For example, the work information may additionally include information according to the work, such as a fastening torque, an angle, an injection amount of liquid, or the like.

For example, the working unit 200 should perform three fastening tasks, and performs tasks at 14:31:21 and 14:32:34. In this case, the working unit 200 transmits a work result and a working time to the server 300 at each time.

For example, the working unit 200 performs first and second tasks, does not perform a third task or performs defective work that does not perform the fastening with an accurate torque and angle, and exits the working area wa.

In this case, when the working unit 200 completes the first task at 14:31:21, the working unit 200 transmits “OK” information indicating that the fastening is accurately conducted at 14:31:21 to the server 300, after completing the task. Further, when the working unit 200 completes the second task at 14:32:34, the working unit 200 transmits “OK” information indicating that the fastening is accurately conducted at 14:32:34 to the server 300, after completing the task.

Further, when the working unit 200 does not perform the third task, the working unit 200 cannot transmit the work information to the server 300 because the work information is not present. Alternatively, when the working unit 200 performs the defective work, the working unit 200 transmits “14:33:34,” which is a work completion time, and “NG” information, which is information indicating that the work is defective, to the server 300. Here, “OK/NG” is determined by the tool 210 or the control unit 220 and transmitted to the server 300. In this case, the information indicating that the work is defective may be determined by comparing, by the control unit 220 or the tool 210 and/or the equipment, the torque and angle and a determined torque and angle.

In operation (f), the server 300 receives the work information from the working unit 200. In this case, the work information may include the above-described work completion time and work result. In this case, the received work information may be information on the sub-task. That is, the server 300 receives work information for each of several tasks constituting one task. For example, when the sub-task includes three fastening tasks, the server 300 may receive “OK” (work result) at 14:31:21 (work completion time), “OK” (work result) at 14:32:34 (work completion time), and “NG” (work result) at 14:33:34 (work completion time).

In operation (g), the server 300 stores the received work information. The server 300 stores the consecutively received work information in a database. In this case, the server 300 may store the work information when the working unit exits the working area in operation (e). For example, the server 300 may determine whether the main task is finished by determining whether the working unit exits the working area. Specifically, when the server 300 receives exit information, the server 300 may determine that the main task of fastening has been completed, and store the work information on the three sub-tasks, which is received so far. In this case, the work information may not match the product information. Of course, the present invention is not limited thereto.

4. Meanwhile, the working unit 200 ends the main task.

5. When the work is completed, the working unit 200 moves away from the vehicle 11 on which the work is completed to work on the next vehicle 11. In this case, the working unit 200 may move even without an instruction from the server 300. Alternatively, the working unit 200 may move according to an instruction from the server 300.

In operation (e), in other words, when it is determined that the working unit 200 has entered the working area wa, the server 300 consecutively checks the position of the working unit 200 to consecutively determine whether the working unit 200 has exited the working area wa.

When it is determined that the working unit 200 has not exited the working area wa, the server 300 may determine whether or not the working unit 20 exits the working area wa until the working unit 200 exits the working area wa. Additionally, the server 300 may notify or command the working unit 200 to exit the working area wa.

In operation (h), when it is determined that the working unit 200 has exited the working area wa, the server 300 may generate and store exit information. In this case, the exit information may include an exit time, a tag ID of the tag device of the working unit 200, or the like. That is, the exit information may include information (exit time) on when the working unit 200 exits, or may include information on which working unit 200 (e.g., worker, tool 210, or equipment) exits and when the working unit 200 exits.

In this case, the server 300 may map and store the exit information and the above-described product information (e.g., tag ID of the vehicle tag device 110 or ID number of the vehicle 11). In operation (i), accordingly, the vehicle 11 may manage work details and work quality.

In operation (i), the server 300 maps and stores the product information (e.g., tag ID of the vehicle tag device 110 or ID number of the vehicle 11) and the work information. In this case, the server 300 may map and store the product information and the exit information, and then may map and store the product information and the work information. Alternatively, the server 300 may simultaneously perform the mapping and storage of the product information and the exit information and the mapping and storage of the product information and the work information.

Since the server 300 may perform several sub-tasks within one main task, the server 300 may map the product information and the work information when one main task is completed, to effectively manage the product information and the work information.

In operation (j), the server 300 may determine whether the work is successful on the basis of the entry information, the exit information, and the work information. That is, the server 300 may determine a quality assurance result.

More specifically, the server 300 may check the position of the working unit 200 in real time and calculate a stay period during which the working unit 200 stays in the working area wa. For example, the server 300 may calculate the stay period on the basis of the entry time included in the entry information, and the exit time included in the exit information. That is, when the entry time is 14:30:23 and the exit time is 14:35:23, the stay period is 5 minutes.

Then, the server 300 may determine whether the work is successful on the basis of the work information received from the working unit 200, and the stay period.

As an example, when the server 300 receives the work information corresponding to the work assigned to the working area wa, the server 300 determines that the work has been successfully completed.

More specifically, the main task is storing or loading that it is three sub-tasks of performing fastening. When three fastening tasks are performed, the server 300 receives three pieces of work information.

The server 300 receives work completion times of 14:31:21, 14:32:34, and 14:33:34, which are times when the fastening is completed, from the working unit 200. Here, the working time may be a work completion time. Further, the server 300 receives a normal work result (all “OK”) corresponding to each of “14:31:21,” “14:32:34,” and “14:33:34.”

Since the server 300 receives three pieces of work information corresponding to the tasks assigned between 14:30:23 and 14:35:23, which are stay periods, and in particular, receives the working time and the work result, it is determined that the tasks have been successfully completed.

That is, since the server 300 receives three working times corresponding to the tasks assigned within a previous five-minute stay period, it is determined that three tasks have been performed, and since the server 300 receives three work results indicating that the tasks have been properly completed, it is determined that three tasks have been successfully completed.

As another example, the server 300 receives “OK” (work result) at 14:31:21 (work completion time), “OK” (work result) at 14:32:34 (work completion time), and “NG” (work result) at 14:33:34 (work completion time).

Since the server 300 receives three working times during a five-minute stay period, it is determined that three tasks have been performed. However, since the server 300 receives one “NG” result, it is determined as a job failure. Then, the server 300 commands the worker to stop the conveyor so that the worker may perform complementary work.

As still another example, the server 300 receives “OK” (work result) at 14:31:21 (work completion time) and “OK” (work result) at 14:32:34 (work completion time).

Since the server 300 receives two work completion times within a five-minute stay period, the received work completion time is insufficient for the three assigned tasks, and thus it is determined as a job failure. Then, the server 300 commands the worker to stop the conveyor so that the worker may perform complementary work.

As described above, since the server 300 determines whether the work is successful on the basis of the entry/exit information, the work, and the work information of the working unit 200, it is possible to effectively detect defective work, thereby improving the reliability of quality of the vehicle 11.

Additionally, the worker may generate quality information corresponding to the quality assurance result, and map and store the generated quality information and the product information.

Meanwhile, a quality assurance method performed by a system for work quality assurance in vehicle manufacturing according to another embodiment of the present invention will be described. The quality assurance method according to the present embodiment is similar to or identical to the operation of the system for work quality assurance according to the above-described embodiment. Therefore, redundant descriptions thereof will be omitted.

The server 300 may perform (a) a setting operation of setting a working area wa of a vehicle 11, (b) a task assignment operation of assigning a task corresponding to the working area wa, (c) an entry determination operation of determining whether a working unit 200 has entered the working area wa, (d) an entry information storage operation of generating and storing entry information when the working unit 200 enters the working area wa, (e) an exit determination operation of determining whether the working unit 200 has exited the working area wa, (f) a work information receiving operation of receiving work information from the working unit 200, (g) a work information storage operation of storing the work information, (h) an exit information storage operation of generating and storing exit information when the working unit 200 exits the working area wa in operation (e), (i) a work information mapping operation of mapping product information of the vehicle 11 and the work information, and (j) a work quality determination operation of determining whether the work is successful on the basis of the entry information, the exit information, the work, and the work information of the vehicle 11.

Further, a detailed description of each operation will be omitted because it is similar to or identical to that described above.

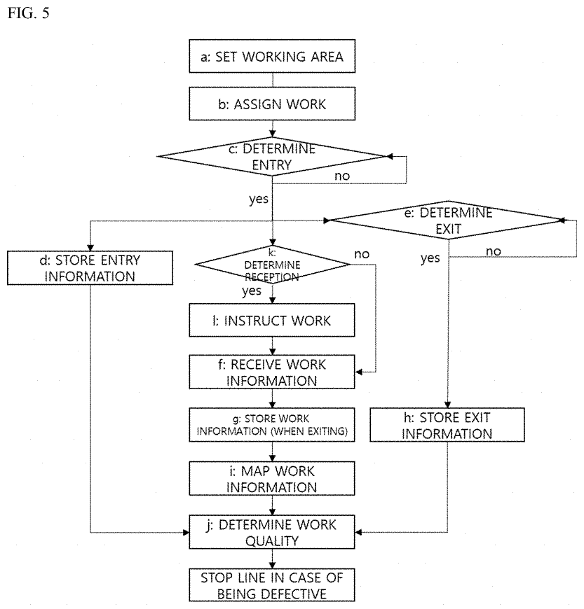

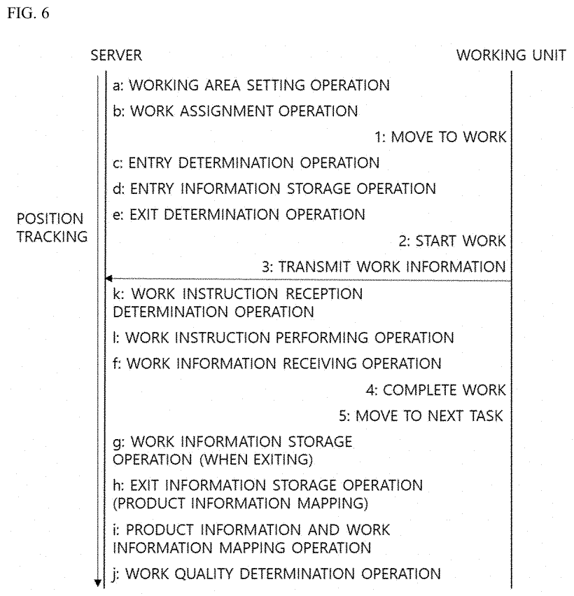

Meanwhile, FIGS. 5 and 6 are flowcharts schematically illustrating a system and method for work quality assurance in vehicle manufacturing according to another embodiment of the present invention. Since the system and method for work quality assurance in vehicle manufacturing are similar to or identical to the system and method for work quality assurance in vehicle manufacturing according to the above-described embodiment, redundant descriptions thereof will be omitted.

The server 300 performs operation (c) an entry determination operation of determining whether the working unit 200 has entered the working area wa, and then performs operation (k) a determination operation of determining whether the working unit 200 can receive a work instruction. For example, in the case of automated equipment, the server 300 may give a work instruction. However, in the case of the simple tool 210, the server 300 corresponds to the working unit 200 that cannot give a work instruction.

When the working unit 200 cannot give the work instruction, the operations are the same as those in the above-described embodiment.

However, when the working unit 200 can receive the work instruction, the server 300 may give the work instruction in operation (f). Subsequent operations are the same as those in the above-described embodiment.

According to the system and method for work quality assurance in vehicle manufacturing according to the embodiments of the present invention, it is possible to prevent defects that may occur during manufacturing processes.

Of course, the scope of the present invention is not limited by the above effect.

The present invention has been described with reference to embodiments illustrated in the accompanying drawings, but these are only examples. It will be understood by those skilled in the art that various modifications and other equivalent embodiments may be made. Therefore, the scope of the present invention is defined by the appended claims.

What is claimed is:

1. A system for work quality assurance in vehicle manufacturing, which assembles fastening objects to a vehicle transferred through a conveyor line through a working unit, the system comprising a server configured to:
set a working area of the vehicle;
assign work corresponding to the working area;
check a position of the working unit in real time to calculate a stay period during which the working unit stays in the working area;
receive work information from the working unit; and
determine whether the work is successful on the basis of the stay period, the assigned work, and the work information.

2. The system of claim 1, wherein the work information includes a working time, at which the working unit completes the work, and a result of the work.

3. The system of claim 2, wherein, when the working time corresponding to the work and the result of the work are satisfied during the stay period, the server determines that the work is successful.

4. The system of claim 3, wherein, when the working time corresponding to the work and the result of the work are not satisfied during the stay period, the server commands to stop the conveyor line.

5. A system for work quality assurance in vehicle manufacturing, which assembles fastening objects to a vehicle transferred through a conveyor line through a working unit, the system comprising a server configured to set a working area of the vehicle, assign work corresponding to the working area, and check a position of the working unit in real time,
wherein the server performs:
(a) an operation of setting a working area of the vehicle;
(b) an operation of assigning work corresponding to the working area;
(c) an operation of determining whether the working unit has entered the working area;
(d) and (e) operations of generating and storing entry information when the working unit enters the working area, and determining whether the working unit has exited the working area;
(f) and (g) operations of receiving work information from the working unit and storing the received work information;
(h) an operation of, when it is determined in operation (e) that the working unit has exited the working area, generating and storing exit information;
(i) an operation of mapping product information of the vehicle and the work information; and
(j) an operation of determining whether the work is successful on the basis of the entry information, the exit information, the work, and the work information of the vehicle.

6. The system of claim 5, wherein the server calculates a stay period during which the working unit stays in the working area on the basis of the entry information and the exit information, and
when the work information indicating that the work is performed within the stay period is present, the server determines that the work is successful.

7. The system of claim 6, wherein, when the work information including a working time and a result of the work is present within the stay period and when the result of the work is normal, the server determines that the work is successful.

8. The system of claim 6, wherein the server maps the entry information and the exit information to the product information.

9. A work quality assurance method performed by a system for work quality assurance in vehicle manufacturing which assembles fastening objects to a vehicle transferred through a conveyor line through a working unit, the system comprising a server configured to set a working area of the vehicle, assign work corresponding to the working area, and check a position of the working unit in real time,
wherein the server performs:
(a) a working area setting operation of setting a working area of the vehicle;
(b) a work assignment operation of assigning work corresponding to the working area;
(c) an entry determination operation of determining whether the working unit has entered the working area;
(d) an entry information storage operation of generating and storing entry information when the working unit enters the working area;
(e) an exit determination operation of determining whether the working unit has exited the working area;
(f) a work information receiving operation of receiving work information from the working unit;
(g) a work information storage operation of storing the work information;
(h) an exit information storage operation of generating and storing exit information when the working unit exits the working area in operation (e);
(i) a work information mapping operation of mapping product information of the vehicle and the work information; and
(j) a work quality determination operation of determining whether the work is successful on the basis of the entry information, the exit information, the work, and the work information of the vehicle.

10. The work quality assurance method of claim 9, wherein, in the work quality determination operation, when the work information including a working time and a result of the work is present within a stay period and the result of the work is normal, the server determines that the work is successful.

11. The work quality assurance method of claim 9, wherein the server maps the entry information and the exit information to the product information.
